(19) United States
(12) Patent Application Publication
(10) Pub. No.: US 2008/0075316 A1
(43) Pub. Date: Mar. 27, 2008

(54) Ear Wrap Headphone or Headset with Ornamental Object

(76) Inventor: Denise M. Chan, East Palo Alto, CA (US)

Correspondence Address: BOZICEVIC, FIELD & FRANCIS LLP, 1900 UNIVERSITY AVENUE, SUITE 200, EAST PALO ALTO, CA, 94303, US

(21) Appl. No.: 10/597,021

(22) PCT Filed: Jan. 7, 2005
(86) PCT No.: PCT/US05/00436

§ 371 Date: May 7, 2007

Related U.S. Application Data
(60) Provisional application No. 60/535,596, filed on Jan. 10, 2004.

(51) Int. Cl. H04R 25/00

(52) U.S. Cl. 381/381

(57) ABSTRACT

Ornamental ear wrap (1) devices are provided. Variations include an ear wrap having an ornamental body attachment (11) portion and an earphone attachment portion (5). Methods of use include wrapping such a device about the ear of a user. Kits or systems may be provided for assembling the ear wrap devices or practicing the subject methods.

### CROSS-REFERENCE

This application claims the benefit of U.S. Provisional Patent Application Ser. No. 60/535,596 filed Jan. 10, 2004, which application is incorporated herein by reference in its entirety.

### FIELD OF INVENTION

This invention relates to audio components, particularly earphone or headset pieces including an ear wrap.

### BACKGROUND

With the increasing use of mobile telephones, considerable attention has been paid to safety issues associated with their use - particularly when used while driving.

Legislators have taken notice that drivers operating automobiles with one hand on the wheel and another on a cell phone is inherently unsafe and have proposed legal restrictions to require drivers to use hands-free phones in which a headset is used so that the user is relieved of the burden of holding the cell phone.

Numerous “hands-free” headset configurations are available today. They offer improved safety associated with the use of mobile phones while driving. They also offer additional flexibility in performing other activities while on the phone.

In addition, headset use often improves the quality of conversation. Specifically, with an earpiece one can better hear the other party to the conversation. Sometimes, noise canceling features or microphone placement also results in better voice pick-up.

To date, few headsets are designed in such a manner that they are aesthetically pleasing. Certainly, some designs are more ergonomic than others. Still, none offer ornamental features as found in jewelry or other user-worn fashion accessories. This lack of visual appeal may cause certain people to shy away from using such “ugly” hardware.

Accordingly, there exists a need for improvement to the styling of headsets. The present invention meets this need and others as may be apparent to those with skill in the art.

### SUMMARY OF THE INVENTION

The present invention is directed to stereo or cellular phone headsets. That is to say, features of the invention applicable to a one-sided design are—likewise-applicable to a two-sided or stereo headset design.

One variation of the invention is a cellular or mobile phone headset in which an ear wrap provides structure to position an earphone speaker on or in the ear of a user. The ear wrap may include an integral portion to receive the speaker or they may be otherwise connected to one another. The headset may include an in-line microphone.

Otherwise, the microphone may be integrated into the wrap or otherwise connected thereto.

However the electronics of the device are configured, the present invention offers a construction that is both functional and aesthetically pleasing. Ornamental or decorative ear wrap devices and methods of using the same are provided. Variations of the invention include an ear wrap having an ornamental body attachment portion and an earphone attachment portion, where embodiments may include an ear wrap that includes at least one ornamental body and a connector for connecting the ear wrap to an earphone.

The invention may include customizable or modular ornamental ear wraps which are configured so that the ornamental body of the ear wrap is interchangeable with another ornamental body. Completed assemblies as well as their constituent parts, provided in packaged combination, or individually, also form part of the invention.

Systems are provided that include at least one of the subject ornamental ear wrap(s). Embodiments may include an ear wrap having an ear phone attachment portion and an ornamental body attachment portion, where embodiments may include a plurality of different, interchangeable ornamental bodies. Systems may include earphones for use with a subject ornamental ear wrap. For example, a system may include one or more ornamental ear wraps and earphone(s) connectable to the ear wrap at a first end and to a technology device (e.g., a telephone, a stereo, a computer, a portable music or video player, etc.) at a second end.

The subject invention also includes methods of using the subject ear wrap devices, where embodiments include wrapping an ear wrap having an ornamental body attachment portion and an earphone attachment portion about the ear of a user, where embodiments include attaching at least one ornamental body to the ornamental body attachment portion and/or attaching a subject ear wrap device to an earphone.

So-attached, the user displays the ornamental object adjacent to her face. Often, the object is forward facing. When the ornamental object is a flower, the display achieves the illusion of a flower tucked behind the ear. Other appearances can be affected as well.

Certain variations of the invention include removing an ornamental body from the device and re-attaching the same ornamental body to the ear wrap device or attaching another ornamental body to the device. Kits for use in practicing such methodology may be provided.

In connection with the exemplary devices and methods or as otherwise covered hereby, the invention provides at least one ear wrap for a user that is or can be highly adorned, comfortable to wear and capture or support an earphone. The ear wraps may be customizable. They may be worn with an earphone as a functional fashion accessory; they may be worn without an earphone and/or microphone—purely—as a fashion accessory. The present invention offers an attractive headset which certain cellular phone users are more likely to wear. By increasing the pool of drivers who will use a headset while on the road, driving safety is improved. Other objects, features, and/or advantages of the present invention will become apparent from a further reading of the following summary, description, drawings, and claims.

### BRIEF DESCRIPTIONS OF THE DRAWINGS

The figures diagrammatically illustrate aspects of the invention. In other words, the figures are not necessarily drawn to scale, with some components and features being exaggerated for clarity. Of these:

FIG. 1 is a front view of an exemplary embodiment of an ear wrap according to the subject invention that incorporates an earphone and an ornamental body;

FIG. 2 is an exploded view of FIG. 1;

FIG. 3 is a partial sectional view of the device in FIG. 1;

FIGS. 4A and 4B are side views of an embodiment of the invention with the ornamental body affixed and detached, respectively.;

FIGS. 5 A and 5B are front and side views of an alternate embodiment that includes an ornamental body in the form of a butterfly which is affixed and detached from the ear wrap body, respectively;

FIG. 6 is a side view of the device of FIG. 1 on a user's ear;

FIG. 7 is a front view of the device of FIG. 1 facing forward, adjacent a user's face;

FIG. 8 is a perspective view of an exemplary headset such as cellular phone headset;

FIG. 9 is a side view of the device of FIG. 1, without an earphone connected thereto, on the ear and face of a subject;

FIG. 10A is a side view of a known Bluetooth™ headset; FIG. 10B shows such a headset modified for use according to the present invention. Variation of the invention from that shown in the figures is contemplated.

### DETAILED DESCRIPTION OF THE INVENTION

Although the invention is described below in reference to several examples, optionally incorporating various features, the invention is not to be limited to that which is described or indicated as contemplated with respect to each variation of the invention. Various changes may be made to the invention described and equivalents (whether recited herein or not included for the sake of some brevity) may be substituted without departing from the true spirit and scope of the invention. Also, it is contemplated that any optional feature of the inventive variations described may be set forth and claimed independently, or in combination with any one or more of the features described herein. Reference to a singular item, includes the possibility that there are plural of the same items present. More specifically, as used herein and in the appended claims, the singular forms “a,” “and,” “said,” and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. Unless defined otherwise herein, all technical and scientific terms used herein have the same meaning as commonly understood by one of ordinary skill in the art to which this invention belongs.

### Ornamental Ear Wrap Devices

As summarized above, embodiments of the invention include ornamental ear wrap devices. The subject devices include a body member that includes or is adapted to include an earphone or the like. The earphone may be set into a flexible socket, captured by a loop of material or otherwise secured. The earphone may be integrated into another body and that body attached to the ear wrap.

The ear wraps of the present invention offer more than a functional ear wrap with earphone. The ear wraps include or are adapted to include at least one distinct fashion or jewelry element (i.e., an ornamental body as described below) intended for adorning the ear, face and/or hair. More specifically, the ornamental object may be a flower, star, or other figure. As used herein, the term “ornamental object” and “ornamental body” and analogous terms are used interchangeably and are intended to mean an element having an ornamental or decorative feature such as an ornamental shape and/or design, or the like, that will decorate a person's ear, face and/or hair. Unlike simple interchangeable color covers that add color to a headset, the ornamental objects herein are preferably in the form of complex two or three-dimensional representational shapes. Examples are provided below.

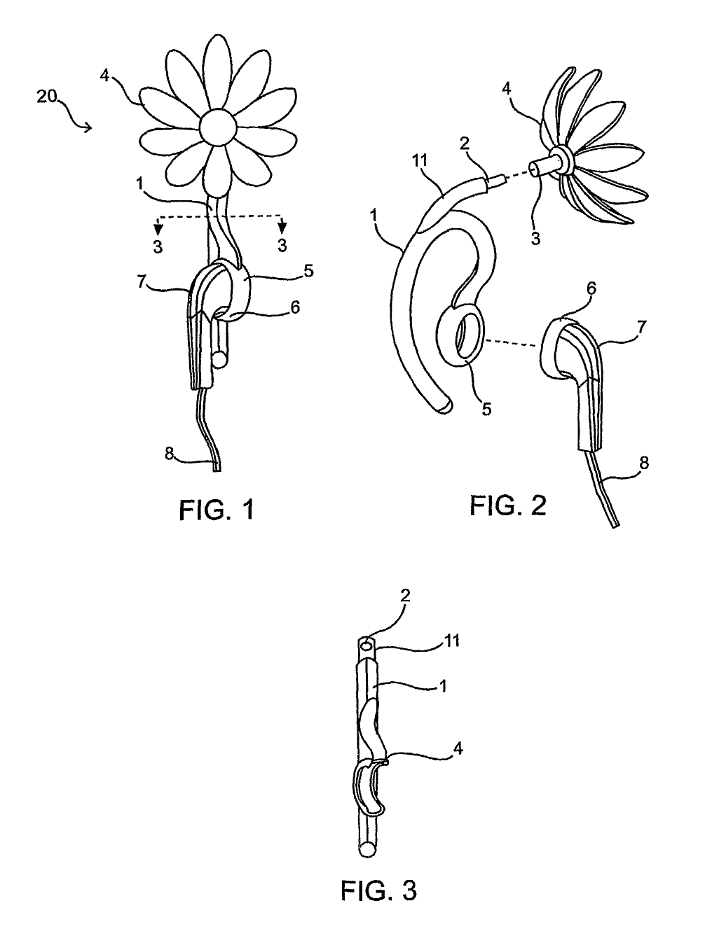

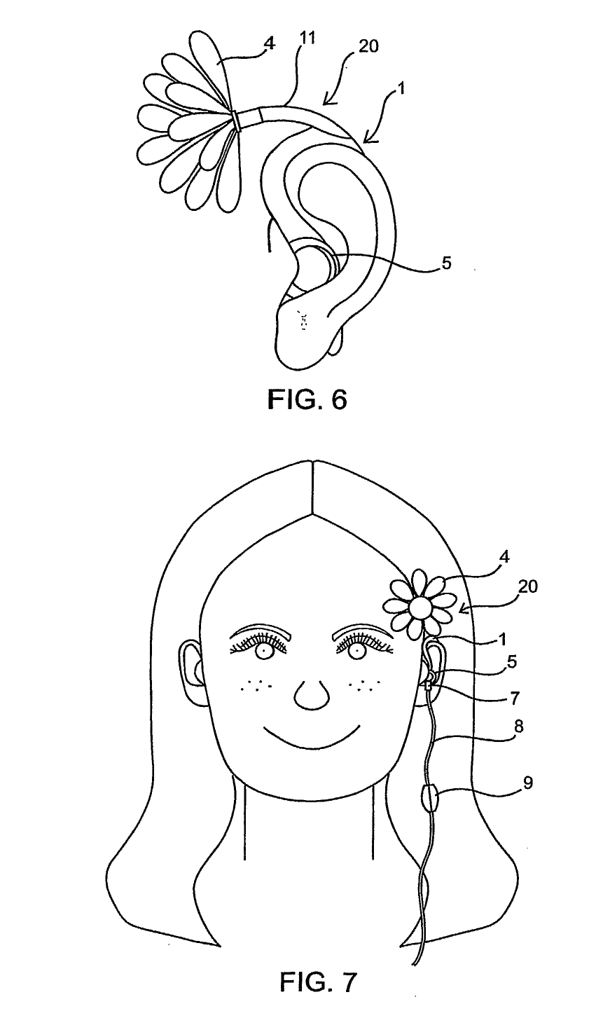

One variation of the present invention is illustrated in FIGS. 1 and 2. An ornamental ear wrap device 20 is shown that includes a curved ear wrap member 1 having an ornamental body 4 attached thereto. Ear wrap 1 is generally shaped to attach to an ear of a user so that the ear wrap is positioned close to the user's head (see for example FIG. 6). In this particular embodiment, ear wrap 1 is shaped as a hook or loop that attaches around an ear. The curved member 1 may generally follow the shape of the ear, as well as zig-zag or spiral forms in certain embodiments.

Ear wrap 1 may be adapted to fit a wide variety of ear shapes and sizes in order to fit a large percentage of users. In certain embodiments, the size and/or shape may be adjustable. For example, in certain embodiments, ear wrap 1 may be made of or incorporate a material that may be easily manipulated by the user into different shapes and/or sizes. In one example, a malleable stainless steel wire is molded without a polymer body. More typically, a flexible polymer body will be employed.

Ear wrap member 1 may be made of any suitable material and may be flexible or rigid, or a portion may be flexible and a portion may be rigid. For example, ear wrap 1 may be made in whole or in part of a rigid material (e.g., metal, plastic, or the like), or may be made in whole or in part of a flexible material (e.g., rubber, foam, stuffed leather, fabric, or the like).

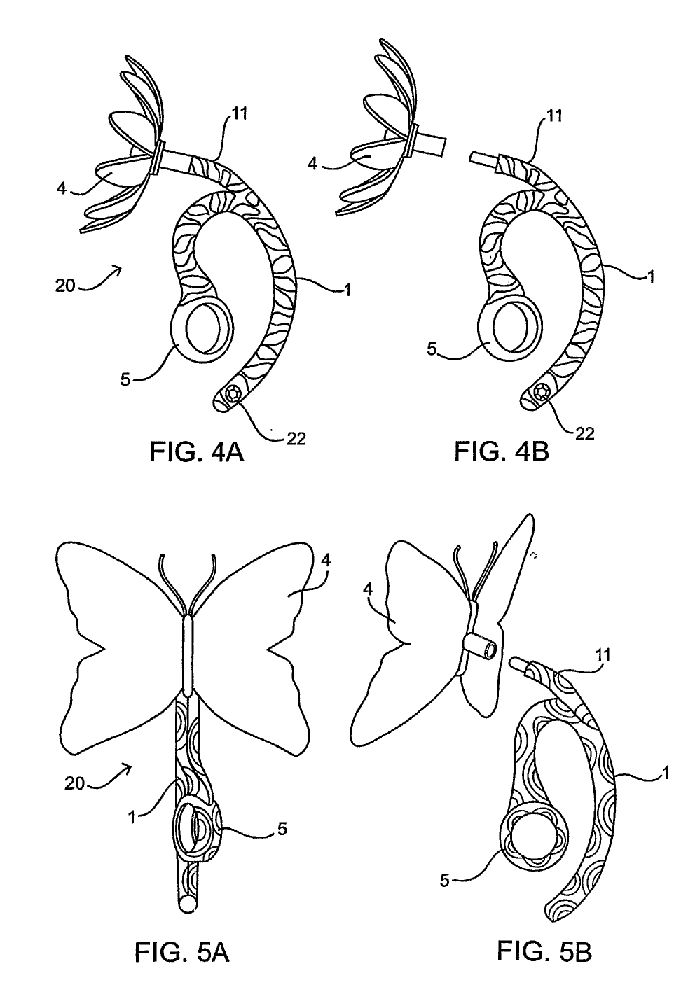

As shown in FIGS. 4A-5B, the ear wrap may have decorative patterns molded into it or painted on it such as swirls, stripes, polka dots, or the like. The curved ear wrap body may have applied decorative components such as precious or semi-precious stones, rhinestones, beads, glitter, embroidery, etc. The curved ear wrap member may be hollow or have decorative grooves or curves. The ear wrap may have a stone 22 (e.g., a semi-precious gem or synthetic) set in its body for further decoration as shown in FIGS. 5A and 5B

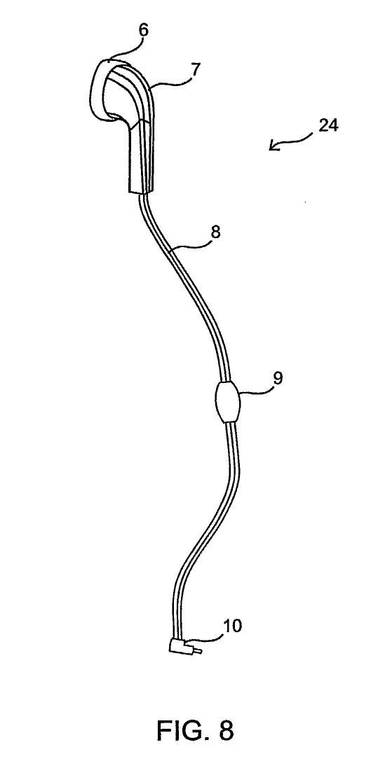

Still further, the color of the ear wrap may be selected to coordinate with that of the ornamental body. So too may be the wires and/or casings of the electronic components used with the device as exemplary shown in FIGS. 7 and 8. In the flower embodiment shown in FIGS. 1 and 2, a green body 1 simulating a stem is particularly attractive.

As shown in FIG. 6, the curved ear wrap is shaped proportionally so as to reside comfortably behind the ear. As noted above, the devices also include or adapted to include an ornamental body 4 or ear ornament, described in greater detail below. As shown in FIG. 7, when the device is worn by the user, the ornamental object faces forward facilitating its display, adjacent (including at least partially overlapping) the face.

As variously shown in the figures, the ear wrap curves forward from a central body portion and may include an earphone attachment portion or earphone connector 5 that rests adjacent to the ear canal. The connector is configured as a loop in the example shown. As shown in FIG. 3, loop 5 may have a C-shaped cross section to fit the lip 6 of an earphone 7.

The earphone attachment means or connector 5 may use any suitable connection for holding an earphone, including any suitable mechanical fit (e.g., snap fit, friction fit, clamp, clasp, wrap). Alternatively, it may be bonded (e.g., glued), fused or welded in place or in connection with body 1.

FIG. 2 shows connector 5 in the form of a socket or loop of material. Depending on the elasticity of the ear wrap material, earphone 7 may be snapped into loop 5 or the loop may be stretched over the earphone. Alternatively, a connector 5 may include a loop segment and a Velcro™ strap (not shown) to wrap around and secure the headset earphone. In any case, the earpiece connection or connector 5 may be adapted to fit any of a number of conventional earphones used in stereo or cellular phone headsets or the like.

FIG. 7 shows a complete cellular phone headset including an earphone 7 as may be received within connector loop 5 is shown in FIG. 7. The headset also includes conductor/line 8, an in-line microphone 9, and a plug or jack 10. Various on/off or call answer and/or volume control switches may be included in the electronics as well.

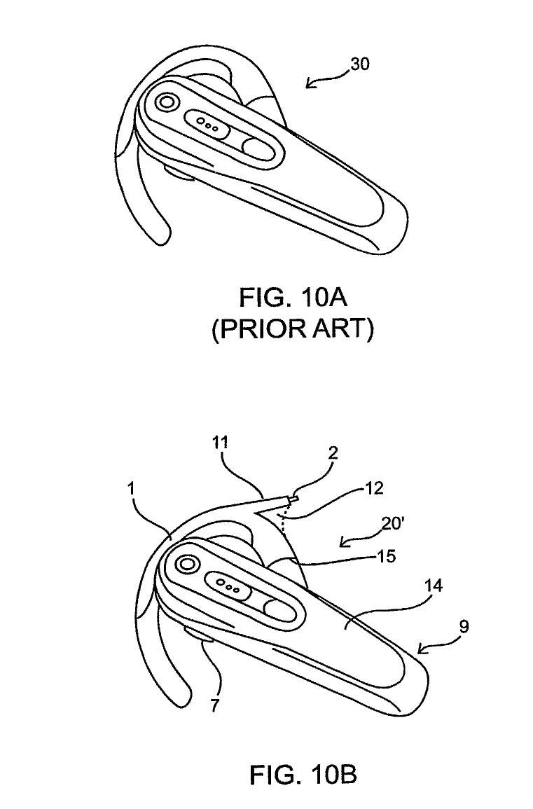

Stereo headphones add a second headphone, while omitting the microphone and/or controls. For use as a mobile phone headset, the microphone may be combined in a body with the earphone. FIG. 1 OA shows an example of such a headset. The microphone may be separated some distance by a boom as shown in FIG. 10A or otherwise configured. Of further note, the headset 30 shown in FIG. 10A is itself wireless, using Bluetooth™ technology to connect with a mobile phone or another compatible device.

Such a device may be modified to include features according to the present invention as shown in FIG. 10B. Here, headset 20′ includes an ear wrap 1, and extension member 11, with optional post 2, etc. The connection to the earphone 7 is via a body or speaker housing 13 that include the earphone speaker 7 and a boom 14 with a microphone 9. Ear wrap 1 and body 14 come together at a swivel joint 15. Alternatively, other means for connecting an earphone speaker to an ear wrap may be employed.

Irrespective of the specific electronic hardware, the ear wrap is configured to suitably position an earphone with respect to a user's ear (e.g., disposed in or adjacent the lower concha area of the ear, adjacent to the ear canal). The subject invention is described primarily as including a connection for an earphone of a cellular phone for exemplary purposes only. It is to be understood that the earphone may be an earphone of any other device that employs one or more earphones. Examples of such devices include computers, CD, MD, DVD, MP3 or other music players, land-line telephones, etc.

Ear wrap 1 also includes an ornamental body attachment portion or means. In one example, an elongate member 11 is provided to attach the ornamental object to the main body of the ear wrap. The extension member may terminate in a post 2. In the embodiments in which the ornamental body attachment member 2 is in the form of a post, a complimentary, mating receptacle 3 may reside on the ornamental body, or vice versa.

Attachment member 2 holds the ornamental body securely onto the ear wrap. A receptacle 3 may be attached to many different ornamental bodies in support of their interchangeability. It will be apparent that an ornamental body may be attached (e.g., removably attached in certain embodiments), to the ear wrap in any suitable manner, including, but not limited to, the post/receptacle attachment means described herein. A suitable means of permanently attaching the extension and ornamental body includes gluing or fusing/welding them together.

The ear wrap provides a stable structure that rides on the ear without discomfort. The extension member diverges from the curvature (at least the interior) of the ear wrap that is intended to match the ear. The extension member is preferably directed forward relative to its wearer, to secure the ornamental device out of range from interference with the subject's face and/or hair.

The extension may take the form of a straight or curved rod-like member or more closely resemble a block or include webbing material 12 as shown in dashed line in FIG. 10B. As noted above, a mid-point attachment position between the extension and ear wrap body may be employed. Alternatively, the extension member may be moved forward or backward and/or upward or downward with respect to the ear wrap body. When the extension is set forward on the body of the wrap, it may advantageously extend in an upward direction, to better display the ornamental piece when the device is worn.

The ornamental body 4 may be any ornamental shape. Its size is typically selected to offer onlookers a clear view. In certain embodiments, ornamental body 4 may be shaped to depict a figure such as a flower (see, for example, FIGS. 1, 2, 4 and 6), butterfly (see, for example, FIG. 5), bee (not shown), heart (not shown), star (not shown), thought bubble (not shown), antlers (not shown), fictional or non-fictional character (not shown), animal (not shown), angel (not shown), flag (not shown), religious icon (not shown), etc. In certain embodiments, the ornamental body may be in the form of a letter or number (e.g., representing the user's initials or age). Each of these various shapes represent complex two or three-dimensional shapes or forms. They are representational or may be symbolic in nature. The ornamental object may comprise a plurality of figures or shapes—as in multiple flower petals or multiple flowers of a bouquet, etc.

The subject devices may be worn on a single ear, or in a pair. In the latter instance, only one of the pair will generally incorporate electronics. Certain of the ornaments are better worn in matched sets. The aforementioned antlers provide one such example. Where pairs of devices are used, it may be the case that only one of the ear wraps includes the connector 5.

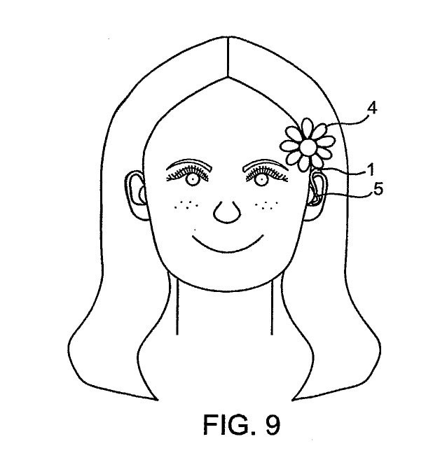

Still further, one or more ear wraps with an ornamental body may be worn without the earphone simply to decorate the face, ear and/or hair as shown in FIG. 9. When the earphone is absent, connector 5 near the front of the ear canal does not impede sound.

Ornamental body 4 may be made of any suitable material and may be flexible or rigid, or may have a flexible portion and a rigid portion. Exemplary material that may be used in the manufacture of an ornamental body include, but are not limited to, plastic, rubber, metal, leather, wood, glass, porcelain, paper, squeezable foam, fabric, etc. An ornamental body may include applied decorative components such as precious stones, semi-precious stones, rhinestones, beads, glitter, embroidery, etc.

In certain embodiments, ornamental body 4 is fixedly (i.e., permanently or irremovably) attached to the ear wrap, however in other embodiments the ornamental body is removably attached to (i.e., detachable from) the ear wrap and in this manner the devices are configured for interchangeability of ornamental bodies, for example, as described above with respect to the post/receptacle configuration. Accordingly, embodiments of the ornamental ear wrap devices may be characterized as interchangeable or modular devices. This modularity allows a user to easily customize an ear wrap to reflect the style and aesthetic needs of the wearer.

### Systems

The subject invention also includes systems that include the subject ornamental ear wraps. Embodiments may include an ear wrap having an ear phone attachment portion and an ornamental body attachment portion and at least one ornamental body attached or attachable to the ornamental body portion of the ear wrap.

In addition to a subject ornamental ear wrap, a system may include an earphone such as the earphone and/or headset system as shown in FIG. 8, where the earphone is operatively attachable to the earphone connector portion of the ear wrap. One or more technology devices as referenced above for use with the earphone may also be included.

In certain embodiments, a system may also include a plurality of different ornamental bodies, and each one may be removably attachable to the ear wrap of the system, as described herein. The system may also include a second ear wrap device as referenced above to provide a matched set for use simultaneously on each ear.

### Methods

Also provided are methods of using the subject ornamental ear wraps. Embodiments of the subject methods include wrapping an ornamental ear wrap of the subject invention about an ear of a user, where certain embodiments may include attaching one or more ornamental bodies to the ear wrap either before, during or after the ear wrap has been wrapped about the ear of the user. Embodiments may include connecting the ear wrap to an earphone. It is to be understood that the steps of the subject methods may be performed in any convenient order and are not limited to any specific sequence.

In attaching an earphone to an ornamental ear wrap device according to FIG. 1, the earphone lip 6 is connected to the earphone connector of the ear wrap. In embodiments in which the earphone connector is in the form of a loop as shown for example in FIG. 1, the earphone is snapped into the loop 5 on the ear wrap 1.

The earphone may be part of, for example, a cellular phone headset as shown in FIG. 8. The earphone may be part of a stereo or two-earpiece headset. In either case, the headset jack or connection is connected to a suitable device as desired. In other instances, an RF, Bluetooth™ or other wireless connection is made.

An ornamental body may be already attached, (e.g., permanently attached), to the ear wrap. In such instances, the user need only to wrap the ornamental ear wrap about the ear to then display the ornamental body.

In those embodiments in which the ornamental body is detachable from the ear wrap, either before or after connecting the earphone to the ear wrap via the earphone connector, an ornamental body may be attached to the ear wrap. The user may select an ornamental body from a plurality of different ornamental bodies and attach the selected ornamental body to the ear wrap.

Attachment may be accomplished in any suitable manner. In those embodiments in which the attachment of an ornamental body to an ear wrap is by way of a post 2 on and receptacle 3 on the ornamental body (or vice versa) the members are simply pushed together.

Once assembled, the ornamental ear wrap with earphone may be worn on the ear and used, for example, for hands-free cellular phone use. As noted above, the ornamental ear wrap may be worn without an earphone connected thereto.

Method of use for the invention also includes removing an ornamental body from an ear wrap and re-attaching it to the ear wrap or replacing or exchanging it with another ornamental body. An ornamental body secured to an ear wrap may be removed therefrom (e.g., by rotating forward and pulling out the ear wrap). The same or a different ornamental body may be secured to the ear wrap in a manner analogous to that described above depending on the user's taste, mood or whimsy.

### Kits

The subject kits may include an ornamental ear wrap. A kit may include an ear wrap and at least one ornamental body. In certain embodiments, the ornamental body may be permanently attached to the ear wrap. In other embodiments, the ornamental body may be removably attached to the ear wrap or provided in the kit un-attached to the ear wrap. A plurality of different ornamental bodies may be included in a kit.

A kit may include various other components for use with the ornamental ear wrap of the kit. For example, a kit may include an earphone connectable to the ear wrap such as the earphone of FIG. 8. In certain embodiments, a kit may include a technology device as referenced above. A kit may also include other accessories for the technology device, such as one or more of a charger (e.g., an auto charger, docking port), protective case, etc.

The subject kits may also include written instructions for using the ornamental ear wrap device of a kit. For example, instructions may describe how to attach and/or remove an ornamental body to/from the ear wrap and/or how to interchange ornamental bodies. Instructions of a kit may be printed on a substrate, such as paper or plastic, etc. As such, the instructions may be present in the kits as a package insert, in the labeling of the container of the kit or components thereof (i.e., associated with the packaging or sub-packaging) etc.

In other embodiments, the instructions are present as an electronic storage data file present on a suitable computer readable storage medium, e.g., CD-ROM, diskette, etc. In yet other embodiments, the actual instructions are not present in the kit, but means for obtaining the instructions from a remote source, e.g. via the Internet, are provided. An example of this embodiment is a kit that includes a web address where the instructions can be viewed and/or from which the instructions can be downloaded. As with the instructions, this means for obtaining the instructions is recorded on a suitable substrate.

In certain embodiments of the subject kits, the components of the kit are packaged in a kit containment element to make a single, easily handled unit, where the kit containment element, e.g., box or analogous structure.

### Manufacture

The constituent parts of the subject invention may be produced as similar components would be by one with ordinary skill in the art. The ear wrap may be injection molded in a polymer or plastic such as urethane, polyurethane, polypropylene, polycarbonate, silicone, etc. The electronics may be custom-made or procured from any of a number of electronics manufacturers. Ornamental flowers, butterflies and the like may be purchased from “silk flower” vendors. Others may be custom-made to order, such as by injection molding, stamping, etc.

The breadth of the present invention is not to be limited by the examples provided and/or the subject specification, but rather only by the plain meaning of the claim terms employed.

That being said, I claim:

1. A device comprising:
a curved body adapted to wrap around at least a portion of an ear,
the body including an earphone or earphone connector and an extension from the curved body to connect an ornamental body.

2. The device of claim 1, further comprising an ornamental body.

3. The device of claim 1, wherein the extension is forward-facing.

4. The device of claim 1, wherein the ornamental body is forward-facing.

5. The device of claim 1, wherein one of the ornamental body and the extension comprises a post and the other comprises a receptacle configured to receive the post.

6. The device of claim 5, wherein the extension comprises the post and the ornamental body is removably attached to the ear wrap by the post and receptacle.

7. The device of claim 1, wherein the ornamental body has a representational shape.

8. The device of claim 1, wherein the shape is in the form of a flower or butterfly.

9. The device of claim 1, wherein the connector comprises a loop.

10. A device comprising:
an ear wrap, the ear wrap comprising a means for attaching an ornamental body and a means for attaching an earphone.

11. The device of claim 10, further comprising an ornamental body attached to the ear wrap.

12. The device of claim 11, wherein the ornamental body is forward-facing.

13. The device of claim 11, wherein the ornamental body is flower or butterfly shaped.

14. The device of claim 11, wherein the ornamental body is permanently attached to the ornamental body attachment portion.

15. The device of claim 11, wherein the ornamental body is removably attached to the ornamental body attachment portion.

16. A system comprising:
an ear wrap comprising an earphone attachment portion and an ornamental body attachment portion; and
a plurality of ornamental bodies having different shapes.

17. The system of claim 16, wherein the different shapes include flower and butterfly shapes.

18. The system of claim 16, further comprising an earphone.

19. The system of claim 18, further comprising an in-line microphone.

20. A method of using an ornamental ear wrap with an earphone by a user with a face and ear having ear canal, the method comprising:
wrapping the ear wrap about the ear;
positioning the earphone adjacent the ear canal; and
displaying the ornamental body adjacent the face.

21. The method of claim 20, further comprising attaching an ornamental body to the ornamental body attachment portion.

22. The method of claim 21, wherein the attaching is accomplished before the wrapping.

23. The method of claim 21, wherein the attaching is accomplished after the wrapping.

24. The method of claim 21, further comprising exchanging one ornamental body attached to the body with another.

25. The method of claim 21, further comprising connecting the earphone to a technology device.
